(19) United States
(12) Patent Application Publication
(10) Pub. No.: US 2011/0097573 A1
(43) Pub. Date: Apr. 28, 2011

(54) MAGNESIUM ALLOY STRUCTURAL MEMBER

(76) Inventors: Nobuyuki Okuda, Osaka-shi (JP); Ryuichi Inoue, Osaka-shi (JP); Masatada Numano, Osaka-shi (JP); Nobuyuki Mori, Osaki-shi (JP); Yukihiro Oishi, Osaka-shi (JP); Nozomu Kawabe, Osaka-shi (JP)

(21) Appl. No.: 12/527,530

(22) PCT Filed: Jan. 9, 2009
(86) PCT No.: PCT/JP2009/000063

§ 371 Date: Aug. 17, 2009

(51) Int. Cl. B32B 15/04

(52) U.S. Cl. 428/336; 428/457; 428/471; 428/335

(57) ABSTRACT

The invention offers a magnesium alloy structural member having a high metallic texture. The magnesium alloy structural member is provided with a base material made of magnesium alloy and a covering layer formed on the base material. The base material is provided, in at least one part of its surface, with a surface-processed portion that is subjected to a fine asperity-forming processing so as to obtain a metallic texture. The covering layer is transparent. The structural member can effectively increase the metallic texture by having the surface-processed portion. Because the structural member is provided with the covering layer, it has excellent corrosion resistance. Because the covering layer is transparent, the metallic texture in the surface-processed portion is readily sensed. The asperity-forming processing is performed through hairline finish, diamond cut finish, and the like.

### TECHNICAL FIELD

The present invention relates to a magnesium alloy structural member provided with a covering layer on a base material made of magnesium alloy, particularly a magnesium alloy structural member having a high metallic texture.

### BACKGROUND ART

Engineers have been using magnesium alloys formed by adding various elements to magnesium as the material of structural members such as housings of portable electric devices including cellular telephones and notebook personal computers and parts of automobiles. Because magnesium alloy is an active metal, surface treatment is performed on the surface of the above-described structural members for corrosion prevention (see Patent Literatures 1 and 2, for example).

In addition, because magnesium alloy has a hexagonally crystalline structure (a hexagonal close-packed structure), it has poor plastic processibility at ordinary temperature. Consequently, the magnesium alloy structural members such as the foregoing housings are mainly produced by casting using the die casting method or the thixomold method. In recent years, engineers have been studying the forming of the above-described housings by pressing a sheet made of AZ31 alloy stipulated in the Standards of the American Society for Testing and Materials (ASTM). Patent Literature 3 has proposed a sheet that is made of alloy equivalent to AZ91 alloy stipulated in the ASTM Standards and that has excellent pressing processibility.
Patent Literature 1: the published Japanese patent application Tokukai 2002-285361
Patent Literature 2: the published Japanese patent application Tokukai 2004-149911

Patent Literature 3: the published Japanese patent application Tokukai 2007-98470.

### SUMMARY OF INVENTION

### Technical Problem

In recent years, the market has been requiring an increase in metallic texture and an enhancement of the sense of high quality and the like on the magnesium alloy structural member such as the above-described housing. Although Patent Literatures 1 and 2 propose a surface-treating agent that does not impair the metallic luster, they do not study the increase in metallic texture. Patent Literature 3, also, does not state the enhancement of the metallic texture.

In view of the above circumstances, an object of the present invention is to offer a magnesium alloy structural member having a high metallic texture.

### Solution to Problem

The present invention attains the foregoing object by offering a structure in which at least one part of the surface of a base material made of magnesium alloy has a surface-processed portion that is subjected to a processing for enhancing the metallic texture. More specifically, the magnesium alloy structural member of the present invention is provided with a base material made of magnesium alloy and a covering layer formed on the base material. In the structural member, the base material is provided, in at least one part of its surface, with a surface-processed portion that is subjected to a fine asperity-forming processing so as to obtain a metallic texture. In addition, the foregoing covering layer is transparent.

Because the magnesium alloy structural member of the present invention is provided with the forgoing surface-processed portion, the metallic texture can be enhanced effectively. In addition, because the structural member of the present invention is provided with the covering layer, it can have sufficient corrosion resistance. In particular, because the covering layer is transparent, light incident from outside passes through the covering layer and tends to be reflected diffusedly at the surface-processed portion. Consequently, the metallic texture can be sensed readily even when viewed from any direction. In short, the structural member of the present invention not only has a desired corrosion resistance but also has a high metallic texture and excellent design quality. The present invention is explained below in further detail.

### Base Material

### Composition of the Base Material

The magnesium alloy constituting the base material of the structural member of the present invention may have a varied composition by adding a different element to Mg (the remainder: Mg and impurities) without being particularly limited. For example, the types of the magnesium alloy include Mg—Al-based alloy, Mg—Zn-based alloy, Mg-RE-based alloy, and Y-added alloy (RE stands for rare earth element). In particular, it is desirable to use an Al-containing alloy, which is Mg—Al-based alloy, because it has high corrosion resistance. The types of the Mg—Al-based alloy include AZ-family alloy (Mg—Al—Zn-based alloy, Zn: 0.2 to 1.5 mass %), AM-family alloy (Mg—Al—Mn-based alloy, Mn: 0.15 to 0.5 mass %), AS-family alloy (Mg—Al—Si-based alloy, Si: 0.6 to 1.4 mass %), Mg—Al-RE-based alloy (RE: rare earth element), and alloys formed by further adding to these Mg—Al-based alloys at least one element selected from the group consisting of Bi, Sn, Pb, Ca, and Be. In the above description, the first three alloys are stipulated in the ASTM Standards. It is desirable that the content of Al be at least 1.0 mass % and at most 11 mass %. When the content of Al is increased, the corrosion resistance and mechanical properties such as strength are improved. Nevertheless, if the content is excessively high, the plastic processibility tends to decrease. Therefore, considering the corrosion resistance, mechanical properties, and formability, it is more desirable that the content be at least 8 mass % and at most 11 mass %. In particular, it is possible to suitably use an Mg—Al-based alloy containing 8 to 11 mass % Al and 0.2 to 1.5 mass % Zn, which is represented by AZ80 and AZ91. These alloys are desirable because even after the fine asperity-forming processing, the surface of the base material is unlikely to tarnish and the metallic texture such as metallic luster can be readily achieved.

### Form of the Base Material

The types of the base material typically include a rolled material formed by rolling a cast material; a processed material formed by further processing the rolled material through heat treatment, leveler processing, polishing, and the like; and a plastically processed material formed by further plastically processing the rolled material or processed material through pressing, bending, forging, and the like. The base material formed by the plastic processing such as rolling or pressing not only has a fine grain size and mechanical properties, such as strength, superior to the cast material but also is few in the number of internal defects, such as a shrinkage cavity and a pore, and surface defects and therefore has good surface quality. The rolled material has a smaller number of surface defects than that of the cast material. Consequently, the operation of putty filling into the defects (defect correction) before the formation of the covering layer can be decreased or even eliminated. Because the occurrence of defect products due to insufficient defect correction can be decreased, the decrease can contribute to the increase in the production yield. The casting condition and the rolling condition are explained below.

### Production Method of the Base Material

### Casting Condition

It is desirable that the cast material be produced by a continuous casting process such as a twin-roll process, particularly the casting method stated in WO/2006/003899. The continuous casting process enables quenching solidification, so that oxide formation, segregation, and so on can be decreased. Consequently, this process can produce a cast material having excellent plastic processibility in a processing such as rolling. The rolling of the cast material can eliminate defects, such as coarse grains of impurities in the crystal and precipitated impurities having a grain diameter of 10 μm or more, which adversely affect the subsequent plastic processing such as pressing. In particular, in the AZ-family alloy, when the amount of Al is increased, the impurities in the crystal and precipitated impurities tend to be readily formed. Nevertheless, the rolling of the above-described continuously cast material can produce a rolled material that is few in the number of the foregoing defects despite its alloy composition. The obtained cast material may undergo a composition-homogenizing heat treatment (a solution heat treatment, heating temperature: 380° C. to 420° C., heating time: 60 to 600 min), an aging treatment, or the like. In particular, in the case of the AZ-family alloy, it is desirable that an alloy having a high Al content be subjected to the solution heat treatment for a long time. The dimension of the cast material is not particularly specified. Nevertheless, if the thickness is excessively large, the segregation tends to occur. Therefore, it is desirable that the thickness be 10 mm or less.

### Rolling Condition

It is desirable that the rolling be performed under the following conditions:
(a) heating temperature of the object to be processed: 200° C. to 400° C.
(b) heating temperature of the roll for the rolling: 150° C. to 250° C.
(c) rolling reduction per pass: 10% to 50%
(d) number of passes: at least twice.
   It is desirable that the foregoing conditions be properly combined in order to obtain a rolled material having a desired thickness. When the above-described conditions of the individual temperatures, rolling reduction per pass, and number of passes are properly combined, a process-undergoing object having a thickness of, for example, 3 to 8 mm before the rolling can be rolled to a thickness of 1 mm or less, more specifically down to 0.2 mm. Well known conditions may be employed, such as the controlled rolling disclosed in Patent Literature 3.

It is desirable to perform an intermediate heat treatment (heating temperature: 250° C. to 350° C., heating time: 20 to 60 min) during the course of the rolling operation. The heat treatment removes or decreases the strain, residual stress, aggregated structure, and the like introduced into the process-undergoing object through the processing before the heat treatment. Thus, the heat treatment prevents unexpected cracks, strain, and deformation during the subsequent rolling, enabling a smoother rolling operation. It is desirable to perform a final heat treatment after the final rolling operation, because a rolled material having an excellent strength can be obtained. The rolled material before the final heat treatment has a crystal structure in which the processing strain is considerably accumulated. In this state, the final heat treatment can transform the structure into a fine recrystallized structure, enabling the improvement in strength. The rolled material after the final heat treatment having the above-described recrystallized structure is less susceptible to the coarsening of the crystal grain due to the heating at the time of the pressing operation. For example, in the case of the AZ-family alloy, it is desirable that the heating temperature of the final heat treatment be raised when the Al content is increased. When the Al content is 8 to 11 mass %, it is desirable to employ a heating temperature of 300° C. to 340° C. and a heating time of 10 to 30 minutes. In the foregoing heat treatments, if the temperature is excessively high or the heating time is excessively prolonged, the crystal grain is excessively coarsened, thereby decreasing the plastic processibility in a processing such as pressing.

The rolled material formed by the above-described rolling is low in variations in grain size, low in segregation at the time of casting (the types of segregation include an intermetallic compound such as Mg₁₇Al₁₂), and low in internal and surface defects. Consequently, it has high plastic processibility, so that it effectively reduces the development of cracks and fissures during the processing. As a result, it has excellent surface quality.

### Preliminary Processing Before the Plastic Processing After the Rolling

It is desirable that the obtained rolled material be subjected to a leveler processing to rectify the wave of the rolled material, the orientation of the crystal grains, and so on and to a polishing operation to smooth the surface of the rolled material. The leveler processing is carried out by passing the rolled material through a roller leveler, for example, and the polishing operation is typically performed by employing the wet belt polishing. It is desirable to use an abrasive powder of No. 240 or more, more desirably No. 320 or more, and particularly desirably No. 600. A rolled material having undergone the above-described preliminary processing and a plastically processed material formed by further plastically processing the foregoing rolled material through pressing or the like enable the easy and uniform performing of the below-described asperity-forming processing.

### Plastic Processing

It is desirable to perform the plastic processing, such as pressing, deep drawing, forging, blow forming, and bending, in such a temperature range that the structure of the rolled material does not become a recrystallized structure and therefore the mechanical property of the rolled material does not change considerably. More specifically, it is desirable to perform the foregoing processing at a temperature of 250° C. or less, particularly desirably in a temperature range of 200° C. to 250° C. When the plastic processing is performed on a rolled material at the above-described temperature, the size of the crystal grain in a portion free from plastic deformation remains almost unchanged. Consequently, the strength at this portion is less likely to change due to the plastic processing. Therefore, this portion can maintain the high strength. As a result, a plastically processed material having high strength can be obtained.

The above-described plastic processing may be performed at any opportunity in the following stages:
(a) before the below-described asperity-forming processing,
(b) after the asperity-forming processing,
(c) before the formation of the below-described covering layer, and
(d) after the formation of the covering layer.

A heat treatment may be performed after the plastic processing in order to remove the strain and residual stress introduced through the plastic processing so that the mechanical property can be improved. The typical conditions of the heat treatment are as follows:
(a) heating temperature: 100° C. to 450° C., and
(b) heating time: 5 minutes to 40 hours or so.

### Surface-Processed Portion of the Base Material

The structural member of the present invention has a feature in which the base material is provided, in at least one part of its surface, with a surface-processed portion that is subjected to a fine asperity-forming processing. The asperity-forming processing contributes to the enhancement of the metallic texture. Specifically, the asperity-forming processing includes at least one of surface cutting, grinding, blasting, and acid-using etching. More specifically, the asperity-forming processing includes at least one of hairline finish, diamond cut finish, spin cut finish, shot blast processing, and etching processing. The structural member of the present invention may undergo the asperity-forming processing composed of one of the foregoing processings or a combination of at least two of them.

The fine asperity is specifically shown as a surface roughness, Rmax (the maximum height: the distance from the lowest position to the highest position), of at least 1 μm and at most 200 μm. When the asperity falls within the foregoing range, light incident from outside to the structural member of the present invention is reflected diffusedly at the surface of the structural member. Consequently, the metallic texture can be sensed sufficiently even when the structural member is viewed from any direction. If the surface condition is relatively smooth as shown by the asperity of less than 1 μm, the metallic texture is unlikely to be enhanced, although the surface can acquire practically the same excellent metallic luster as that of the condition produced by the mirror finishing. If the surface condition is coarse as shown by the asperity of more than 200 μm, the metallic texture is unlikely to be achieved. It is more desirable that the surface roughness, Rmax, be at least 1 μm and at most 50 μm. To increase the bonding quality between the base material and the covering layer, the surface of the base material is sometimes coarsened. Nevertheless, this coarsening is performed to such an extent that the surface luster is not impaired. Therefore, it is unlikely that the metallic texture can be obtained.

The above-described surface-processed portion may be formed only at one part of the surface of the base material. However, when the structural member of the present invention has a front face and a back face, the surface-processed portion may be formed either only on the front face (the entire face at one side) or on the entire face (the entire face of the front and back faces). Nevertheless, in the case where the metallic texture may be decreased when the above-described plastic processing is performed after the asperity-forming processing and consequently the plastic processing damages the asperity, it is desirable to perform the asperity-forming processing after the plastic processing. In particular, when the surface-processed portion extends to the entire face at one side or to the entire face of the front and back faces, this condition increases the possibility of the damaging of the asperity due to the plastic processing. Therefore, in this case, it is desirable to perform the asperity-forming processing after the plastic processing. Alternatively, when the plastic processing is performed by preventing the asperity of the surface-processed portion from being damaged with consideration given to the lubricant and other factors at the time of the plastic processing, the plastic processing can be performed after the asperity-forming processing. For example, the material having undergone the asperity-forming processing can be processed by pressing or the like under the condition that the material is sandwiched between Teflon (registered trade mark) or other fluororesin sheets. When such a plastic processing is performed, the structural member obtained after the plastic processing can maintain almost the same surface configuration as that of the material before the plastic processing. Consequently, for example, when a material having undergone the asperity-forming processing on its entire surface is used, the use of this material enables an easy production of a structural member that has a base material whose entire surface is composed of the surface-processed portion.

### Covering Layer

The structural member of the present invention has another feature in which the structural member is provided with a transparent covering layer on its surface. The providing of the transparent covering layer on the base material enables easy visual confirmation of the surface-processed portion provided on the surface of the base material and therefore it is easy to sense the metallic texture. The covering layer may be colored and transparent. Nevertheless, when it is colorless and transparent, it becomes possible to sense even the shade of color and the feel of the base metal itself of the base material. As a result, it is likely to sense the metallic texture more readily. The term “transparent” is used to mean such a degree that the base material can be visually confirmed.

It is desirable that the covering layer have at least corrosion resistance. It is also desirable that the covering layer further have ornamental quality to enhance the commercial value. For example, the covering layer can have a multilayer structure composed of an anticorrosion layer, which has corrosion resistance, and a coating that functions for the protection, ornament, and so on. The anticorrosion layer is placed on the base material and the coating is placed on the anticorrosion layer.

The above-described anticorrosion layer is not particularly specified on condition that it has desired corrosion resistance. A typical example of the anti-corrosion layer is formed by anticorrosion treatment (chemical conversion treatment or anodic oxidation treatment). When the foregoing anticorrosion treatment is performed, magnesium on the surface of the base material is oxidized, forming an oxide of magnesium. The layer composed of the oxide functions as the anticorrosion layer. The anticorrosion layer may be formed either before the plastic processing such as pressing or after the plastic processing. When the anticorrosion layer is formed before the plastic processing, the layer is likely to act as a lubricant at the time of the plastic processing. Furthermore, because the anticorrosion layer is in a state in which microscopic cracks (crazings) are formed, the constituting material of the coating penetrates into the cracks, increasing the bonding quality between the two layers, which is desirable.

It is desirable that the foregoing anticorrosion layer have a low surface resistivity, more specifically at most 0.2 Ω·cm. When this condition is met, the anticorrosion layer can be used for grounding in the case where the structural member of the present invention is used as the housing of an electronic device. The surface resistivity can be decreased by decreasing the thickness of the covering layer, for example. When the anticorrosion layer has a thickness of 2 μm or less, the layer is likely to have low resistance. When the anticorrosion layer has a thickness as thin as 2 μm or less, particularly 0.5 μm or less, the sense of transparency can be readily achieved. In the case of the above-described housing of an electronic device, the face to be used for grounding (often the back face of the housing) is not required to have ornamental quality in many instances. Consequently, the covering layer on this face may be composed only of the anticorrosion layer, without being provided with the coating. It is recommendable to form a coating only at a desired region by properly providing masking or the like on the area where only the anticorrosion layer is to be provided (for example, an area that is desired to have low surface resistance).

The anticorrosion layer may be formed by using a transparent sur face-treating agent such as stated in Patent Literature 1.

The above-described coating is not particularly specified providing that it is transparent, it has excellent bonding quality with the anticorrosion layer, and it is good to a certain extent in corrosion resistance and surface hardness. For example, a transparent fluororesin or the well-known clear coating composed of resin such as a transparent acrylic resin may be used. To form the coating by using the foregoing resin or the like, either of the wet process (the dip coating, spray coating, electrostatic painting, or the like) or the dry process (the physical vapor deposition or chemical vapor deposition) may be used. Because the structural member of the present invention is provided with the foregoing transparent coating, not only is the metallic texture increased but also the commercial value is enhanced. When there is a possibility that the coating may be damaged by the plastic processing, it is desirable to form the coating after the plastic processing. In consideration of the good expressing ability of the metallic texture at the surface-processed portion and the easiness of production, it is desirable that the coating have a thickness of at most 30 μm. If the thickness of the coating is increased, reflected lightwaves of the lightwaves incident from outside may interfere with one another. When this interference occurs, the sharpness of the surface-processed portion becomes blurred and consequently the metallic texture is decreased.

### Advantageous Effects of Invention

The magnesium alloy structural member of the present invention has a high metallic texture and therefore enables an increase in commercial value.

### DESCRIPTION OF EMBODIMENTS

Embodiments of the present invention are explained below.

### TEST EXAMPLE 1

A press-formed body provided with a base material made of magnesium alloy and a covering layer that covers the surface of the base material was produced to perform a panel test (a test by panelists) to evaluate its appearance.

The base material is produced as shown below. A cast material having a thickness of 5.0 mm is produced by the twin-roll continuous casting process. The cast material has a composition of Mg, 9.0 mass % Al, and 1.0 mass % Zn (this composition is equivalent to that of AZ91 alloy). The casting is performed under the condition stated in WO/2006/003899. The cast material is subjected to a rolling operation. The rolling is performed under the following conditions:
(a) heating temperature of the object to be processed (to be rolled): 200° C. to 400° C.
(b) heating temperature of the roll for the rolling: 150° C. to 250° C.
(c) rolling reduction per pass: 10% to 50%
(c) number of passes: at least twice.
   Thus, a rolled sheet having a thickness of 0.5 mm is produced. The obtained rolled sheet undergoes leveler processing and polishing in this order. The sheet is cut to obtain a cut piece having a desired size. The cut piece is subjected to hot press forming to obtain a box-shaped pressed material. The press forming is performed as described below. First, a die is prepared that has a rectangular solid-shaped recessed portion. The cut piece is placed on the die so as to cover the recessed portion. Then, a punch having the shape of a rectangular solid is pressed against the cut piece. The punch has the shape of a rectangular solid with dimensions of 60 by 90 mm. The four corners of the punch that are to be pressed against the cut piece are rounded off with a specified dimension. The die and punch have an embedded heater and thermocouple so as to have a structure that enables the control of the temperature at the time of the pressing to a desired one. In this case, the heating is carried out at 200° C. to 300° C.

An intermediate heat treatment during the course of the rolling operation or a final heat treatment after the rolling operation may be performed in order to remove the strain and the like introduced into the rolled sheet through the rolling operation carried out before the heat treatment. The rolling operation may be performed after conducting a solution heat treatment on the cast material.

### Test Material 1-A

The entire top surface of the protruding side (about 60 by 90 mm) of the obtained box-shaped pressed material is subjected to a diamond cut finish with a processing radius of 50 mm, a depth of 0.02 mm (20 μm), and a pitch of 0.05 mm. This finish is performed using a commercially available diamond cut-finishing machine. This step produces a base material (a pressed material, or a plastically processed material) whose surface-processed portion is formed at the entire top surface of the protruding side using the diamond cut finish.

The foregoing base material undergoes, first, a primary treatment. Then, a multilayer covering layer (an anticorrosion layer and a coating) is formed on it. Thus, a magnesium alloy structural member provided with a base material having a surface-processed portion and with a covering layer is obtained. The primary treatment is performed by the procedure in the order of degreasing, acid etching, desmutting, and surface conditioning. Subsequently, chemical conversion treatment and drying are conducted. Then, an anticorrosion layer having a thickness of about 0.5 μm is formed. Water washing is performed between the consecutive steps in the process from the degreasing to the drying. The coating having a thickness of about 20 μm is formed by the procedure in the order of spray coating and baking. The coating is formed only on the outer surface of the base material (outside of the box), without being formed on the inner surface (inside of the box). For that purpose, masking is provided on the inner surface before the forming of the coating. The individual steps are explained below in detail (the concentration of the individual solutions is expressed in mass %). The material obtained through these steps is referred to as Test material 1-A. When the surface of the base material has a defect, putty filling and polishing may be performed as needed.
Degreasing: through the agitation of a solution of 10% KOH and 0.2% non-ionic surface active agent, at 60° C. for 10 minutes
Acid etching: through the agitation of a 5% organic phosphoric acid solution, at 40° C. for 1 minute
Desmutting: through the ultrasonic agitation of a 10% KOH solution, at 60° C. for 5 minutes
Surface conditioning: through the agitation of a carbonic acid aqueous solution adjusted to pH 8, at 60° C. for 5 minutes
Chemical conversion treatment: through the agitation of a treatment liquid composed of 1% KOH and an A-company-made P-based treatment liquid consisting mainly of 10% phosphoric acid, at 30° C. for 2 minutes
Drying: at 150° C. for 5 minutes
Spray coating: through coating a colorless, transparent acrylic paint by the spray coating method
Baking: at 150° C. for 10 minutes.

### Test Material 1-B

Test material 1-B was produced by forming the base material and covering layer through the same method as used for forming Test material 1-A, except that the above-described diamond cut finish was not performed on the obtained box-shaped pressed material.

The obtained Test materials 1-A and 1-B were subjected to a panel test, the panelists being arbitrarily extracted ten persons. Nine panelists out of ten replied that Test material 1-A had a higher metallic texture and more outstanding design quality. This result shows that the magnesium alloy structural member provided with a base material having on its surface a sur face-processed portion subjected to diamond cut finish and with a transparent covering layer has an enhanced metallic texture. As an alternative to the foregoing panelists for the panel, the panelists may be selected according to the targeted users of the products incorporating the magnesium alloy structural member, such as personal computers and cellular telephones. The targeted users include a group of personal computer-loving young adults at the age of twenties. The same is to be applied to the following test examples.

### TEST EXAMPLE 2

Test material 2-A was produced by the same method as used for producing Test material 1-A in Test example 1, except that the diamond cut finish applied to Test material 1-A was changed to hairline finish. The appearance of Test material 2-A was evaluated by a panel test.

In Test example 2, hairline finish was performed so as to have a surface roughness, Rmax (the maximum height), of 10 μm. The obtained Test material 2-A and Test material 1-B (the material has not undergone hairline finish and diamond cut finish) produced in Test example 1 were subjected to a panel test, the panelists being arbitrarily extracted ten persons. Eight panelists out of ten replied that Test material 2-A had a higher metallic texture and more outstanding design quality. This result shows that the magnesium alloy structural member provided with a base material having on its surface a surface-processed portion subjected to hairline finish and with a transparent covering layer has an enhanced metallic texture.

### TEST EXAMPLE 3

Test material 3-A was produced by the same method as used for producing Test material 1-A in Test example 1, except that the constituting material for the coating of Test material 1-A was changed. The appearance of Test material 3-A was evaluated by a panel test.

In Test example 3, by using the same procedure as used in Test example 1, the preliminary treatment of the base material is performed and the anticorrosion layer is formed on the base material. Subsequently, colorless and transparent fluororesin (SUMIFLON™: trade mark of Sumitomo Electric Industries, Ltd.) is applied and dried. This step produces Test material 3-A provided with a transparent coating having a thickness of 25 μm.

The obtained Test material 3-A and Test material 1-B (the material has not undergone hairline finish and diamond cut finish) produced in Test example 1 were subjected to a panel test, the panelists being arbitrarily extracted ten persons. Nine panelists out of ten replied that Test material 3-A had a higher metallic texture and more outstanding design quality.

### TEST EXAMPLE 4

Test materials 4-1A and 4-2A were produced by the same method as used for producing Test material 1-A in Test example 1, except that the diamond cut finish applied to Test material 1-A was changed to etching processing. The appearance of Test materials 4-1A and 4-2A was evaluated by a panel test.

Test material 4-1A's surface-processed portion was formed by etching processing as shown below. Resist was applied onto the surface of the box-shaped pressed material. A mask having a predetermined pattern was placed on the resist. Exposure to light was conducted. A solvent removed the portion not light-cured. Thus, patterning was completed by forming a predetermined pattern. The exposed portion of the pressed material (the raw material) was subjected to dry etching with a depth of 10 μm using an ion milling device. Finally, the resist was removed. Thus, the top surface of the protruding side (about 60 by 90 mm) of the pressed material was provided with the asperity having a specified pattern.

Test material 4-2A's surface-processed portion was formed by etching processing as shown below. A predetermined pattern was printed on the surface of the box-shaped pressed material through screen printing. The portion uncovered by the printed material was subjected to acid etching with a depth of 20 μm. Finally, the printed material was removed. Thus, the top surface of the protruding side (about 60 by 90 mm) of the pressed material was provided with the asperity having a specified pattern.

The obtained Test materials 4-1A and 4-2A and Test material 1-B (the material has not undergone the asperity-forming processing such as etching processing) produced in Test example 1 were subjected to a panel test, the panelists being arbitrarily extracted ten persons. The test results were as follows. Seven panelists out of ten replied that Test material 4-1A had a higher metallic texture and more outstanding design quality than those of Test material 1-B. Eight panelists out of ten replied that Test material 4-2A had a higher metallic texture and more outstanding design quality than those of Test material 1-B.

The above-described embodiments may be modified as needed without deviating from the gist of the present invention and are not limited to the above-described structure. For example, the following features may be modified as needed: the composition of the magnesium alloy; the conditions for the casting, rolling, and plastic processing; the thickness of the sheet after the casting and after the rolling; the forming method and forming condition in the asperity-forming processing; and the material and method for forming the covering layer.

### INDUSTRIAL APPLICABILITY

The magnesium alloy structural member of the present invention has a high metallic texture and therefore can be suitably used in the field in which the products are required to have high design quality, such as the housing for portable electric devices and the like.

1. A magnesium alloy structural member, comprising:
(a) a base material made of magnesium alloy; and
(b) a covering layer formed on the base material;
wherein:
(c) the base material is provided, in at least one part of its surface, with a surface-processed portion that is subjected to a fine asperity-forming processing so as to obtain a metallic texture; and
(d) the covering layer is transparent.

2. The magnesium alloy structural member as defined by claim 1, wherein the base material is formed of a rolled material made of Mg—Al-based alloy and contains at least 8 mass % and at most 11 mass % Al.

3. The magnesium alloy structural member as defined by claim 2, wherein the base material is a pressed material formed by pressing the rolled material.

4. The magnesium alloy structural member as defined by claim 1, wherein the asperity-forming processing is composed of at least one of surface cutting, grinding, blasting, and acid-using etching.

5. The magnesium alloy structural member as defined by claim 4, wherein the asperity-forming processing is composed of at least one of hairline finish, diamond cut finish, spin cut finish, shot blast processing, and etching processing.

6. The magnesium alloy structural member as defined by claim 1, wherein the surface-processed portion has a surface roughness, Rmax, of at least 1 μm and at most 200 μm.

7. The magnesium alloy structural member as defined by claim 1, wherein the covering layer is provided with an anticorrosion layer placed on the base material and a coating placed on the anticorrosion layer.

8. The magnesium alloy structural member as defined by claim 7, wherein the anticorrosion layer comprises an oxide of magnesium.

9. The magnesium alloy structural member as defined by claim 7, wherein the anticorrosion layer has a thickness of at most 2 μm, except 0 μm.

10. The magnesium alloy structural member as defined by claim 7, wherein the coating has a thickness of at most 30 μm, except 0 μm.

11. The magnesium alloy structural member as defined by claim 7, wherein the coating is composed of transparent resin.

12. The magnesium alloy structural member as defined by claim 8, wherein the anticorrosion layer has a thickness of at most 2 μm, except 0 μm.
